(19) United States
(12) Patent Application Publication
(10) Pub. No.: US 2026/0154301 A1
(43) Pub. Date: Jun. 4, 2026

(54) RETRIEVAL-AUGMENTED GENERATION METHOD AND SYSTEM FOR KNOWLEDGE MANAGEMENT

(71) Applicant: X-UNIV. CO., LTD, Taichung City (TW)

(72) Inventors: Kun-Lin HSIEH, Taichung City (TW); Wei-Jia HUANG, Taichung City (TW)

(73) Assignee: X-UNIV. CO., LTD, Taichung City (TW)

(21) Appl. No.: 19/392,465

(22) Filed: Nov. 18, 2025

Related U.S. Application Data
(60) Provisional application No. 63/726,423, filed on Nov. 29, 2024.

(30) Foreign Application Priority Data
Sep. 25, 2025 (TW) 114137011

(51) Int. Cl. G06F 16/3329; G06F 16/334

(52) U.S. Cl. CPC G06F 16/33295; G06F 16/3347

(57) ABSTRACT

This invention provides a method for retrieval-augmented generation for knowledge management comprises: inputting a first prompt into a first LLM by a processing unit to output a question description and a keyword set; performing retrieval in a vector store by the processing unit after vector embedding the question description and the keyword set; inputting the question description, the keyword set, and each of the knowledge content fragment into a ranking model by the processing unit to output a retrieval result list; inputting a content composer by the processing unit into a second LLM to output a response content or at least one dynamic prompt. By utilizing the first LLM, the ranking model, and the second LLM for understanding, filtering, combination, and structuring, this method effectively leverages large language models while ensuring data confidentiality.

### BACKGROUND OF THE INVENTION

### 1. Technical Field

The present invention relates to a knowledge management system, particularly a method and system for retrieval-augmented generation in knowledge management.

### 2. Description of the Related Art

In recent years, Large Language Models (LLMs) have demonstrated powerful natural language generation and understanding capabilities, finding widespread application in various scenarios. However, LLMs’ knowledge has a limited lifespan, unable to provide real-time information or incorporate the latest changes into generated content. Furthermore, due to limitations in training data, LLMs may hallucinate information and generate factually incorrect content. Additionally, LLMs lack domain-specific background knowledge, leading to inaccurate or completely erroneous responses when addressing highly specialized or niche areas. Finally, updating and maintaining LLMs is costly, a burden that most enterprises cannot afford. This presents significant challenges for their widespread adoption.

To address the aforementioned issues, Retrieval-Augmented Generation (RAG) technology has emerged. RAG utilizes a pre-built knowledge base to provide LLMs with real-time, comprehensive, or domain-specific data, generating more accurate, verifiable, and timely responses. This is particularly useful for providing specialized data within specific knowledge domains, internal company documents, and data, allowing LLMs to be applied in specific professional fields or within enterprises.

However, for applications requiring a high degree of confidentiality, such as internal company technical data, using external LLMs poses the risk of confidential data being exposed as training material. At the same time, building local LLMs is prohibitively expensive. Therefore, resolving this dilemma is a pressing challenge in current artificial intelligence technology.

### BRIEF SUMMARY OF THE INVENTION

In view of the foregoing, an object of the present invention is to provide a retrieval-augmented generation method and system for knowledge management, which divides and decontextualizes raw data to remove contextual information, and provides it to at least two LLMs for generation based on instructions provided by user. This prevents a single external LLM from knowing the entirety of the raw data, thereby protecting the confidentiality of the original data while also saving the cost of creating an LLM independently.

To achieve the foregoing object, the present invention provides a retrieval-augmented generation method for knowledge management, comprising the following steps: inputting a first prompt by a processing unit into a first LLM to output a question description and a keyword set, wherein the first prompt instructing the first LLM to refer to a history record to understand and augment a user input to obtain the question description and the keyword set, the history record being stored in a user database and including a conversation summary record and a browsing record; performing retrieval in a vector store by the processing unit after vector embedding the question description and the keyword set to obtain a plurality of retrieval results, each of the retrieval result including a knowledge content fragment; inputting the question description, the keyword set, and each of the knowledge content fragment into a ranking model by the processing unit to output a retrieval result list, wherein the ranking model comparing the similarity between the question description, the keyword set, and each knowledge content fragment to assign a weight value to each of the retrieval result, and filtering and sorting each of the retrieval result based on the weight value to obtain the retrieval result list; and inputting a content composer by the processing unit into a second LLM to output a response content or at least one dynamic prompt, wherein the content composer including a second prompt and an output instruction, the second prompt including the user input, the history record, the question description, the keyword set, and the retrieval result list being integrated according to the instructions of the content composer, and generating the response content or the dynamic prompt according to the output instruction indicating the number of words generated, the level of detail, style, or way.

The present invention also provides a retrieval-augmented generation system for knowledge management, comprising a memory storing one or more computer programs including a plurality of instructions; and a processing unit configured to execute the instructions to perform the following operations: inputting a first prompt by a processing unit into a first LLM, and then the first LLM outputting a question description and a keyword set, wherein the first prompt instructing the first LLM to refer to a history record to understand and augment a user input, thereby obtaining the question description and the keyword set, the history record being stored in a user database and including a conversation summary record and a browsing record; performing retrieval in a vector store by the processing unit after vector embedding the question description and the keyword set, obtaining a plurality of retrieval results, each retrieval result including a knowledge content fragment; inputting the question description, the keyword set, and each of the knowledge content fragment into a ranking model by the processing unit, outputting a retrieval result list, wherein the ranking model comparing the similarity between the question description, the keyword set, and each of the knowledge content fragment, assigning a weight value to each of the retrieval result, and filtering and sorting each of the retrieval result based on the weight value to obtain the retrieval result list; and inputting a content composer by the processing unit into a second LLM to output a response content or at least one dynamic prompt, wherein the content composer including a second prompt and an output instruction, the second prompt including the user input, the history record, the question description, the keyword set, and the retrieval result list being aggregated according to the instructions of the content composer, and generating the response content or the dynamic prompt according to the output instruction indicating the number of words generated, the level of detail, style, or way.

Through the above steps, the retrieval-augmented generation method and system for knowledge management provided by the present invention pre-stores various texts divided, indexed, and converted into vector data in a vector store, and further understands, filters, combines, and structures through a first large language model, a ranking model, and a second large language model to independently and precisely generate response content or dynamic prompts. It effectively integrates at least two large language models to complete instructions and confidential data protection through the process of disassembling and reassembling, as well as utilizing different large language models.

### BRIEF DESCRIPTION OF THE SEVERAL VIEWS OF THE DRAWINGS

FIG. 1 is a block diagram illustrating a retrieval-augmented generation system for knowledge management according to one or more embodiments of the invention;

FIG. 2 is a flowchart illustrating a method for knowledge management using retrieval-augmented generation according to one or more embodiments of the invention;

FIG. 3 is a schematic diagram illustrating the operation of a retrieval-augmented generation method for knowledge management according to one or more embodiments of the invention;

FIG. 4 is a flowchart illustrating a retrieval-augmented generation method for knowledge management according to one or more embodiments of the invention; and

FIG. 5 is a schematic diagram illustrating the operation of a retrieval-augmented generation method for knowledge management according to one or more embodiments of the invention.

### DETAILED DESCRIPTION OF THE INVENTION

The following description refers to the accompanying drawings, which illustrate one or more embodiments of a retrieval-augmented generation method and system for knowledge management in accordance with the invention. In addition, identical components and elements are indicated in the same reference numerals for the description.

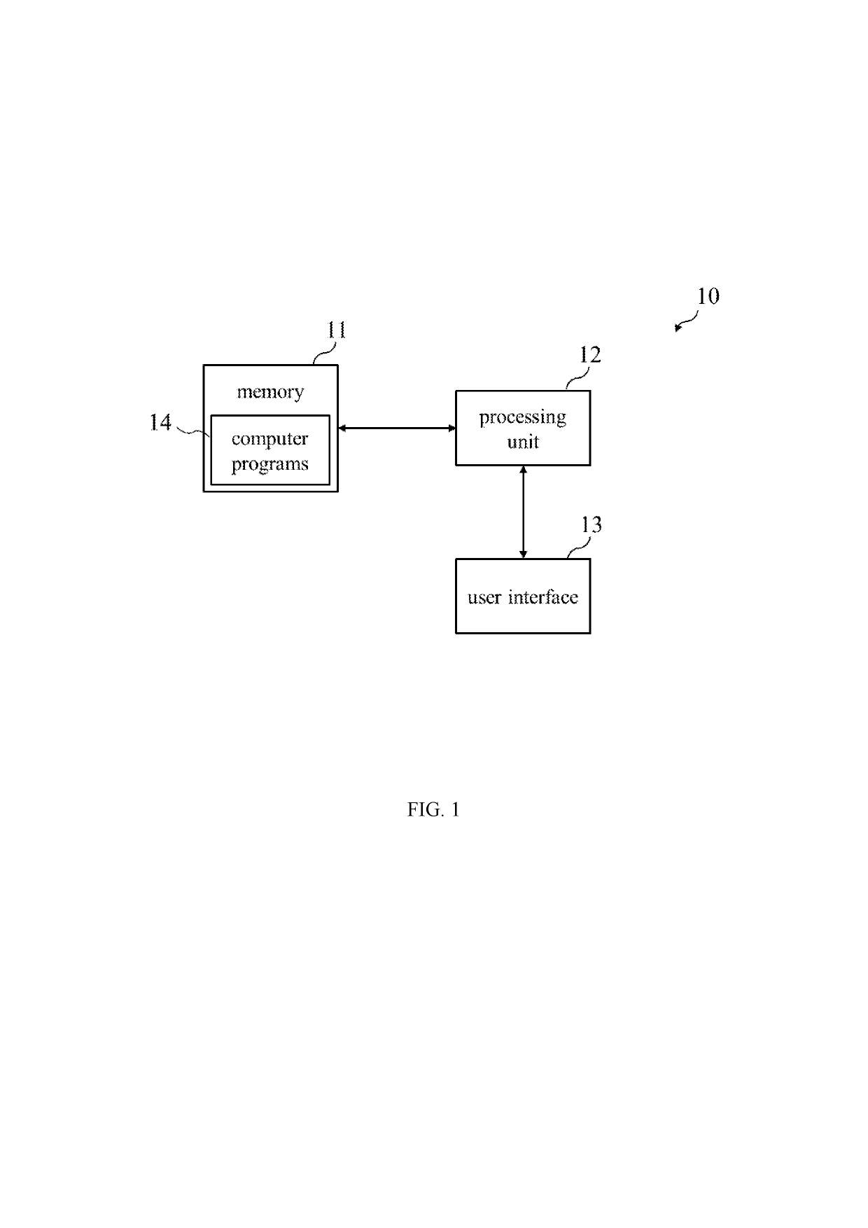

Referring to FIG. 1, a retrieval-augmented generation system for knowledge management 10 includes a memory 11, a processing unit 12, and a user interface 13. The memory 11 is electrically coupled to the processing unit 12, and the processing unit 12 generates the user interface 13. Wherein, the memory 11 can be a non-transitory computer-readable medium, such as read-only memory, flash memory, a hard disk, an optical disc, a USB drive, an online database, or other accessible media, for storing one or more computer programs 14 including a plurality of instructions. The processing unit 12 can be a central processing unit or a microprocessor. The user interface 13 allows the user to interact with and operate the computer program 14 stored in the memory 11 through the processing unit 12, and may include devices such as a keyboard, mouse, touchpad, or a touchscreen associated with a mobile electronic device (such as a cell phone, tablet), which are not shown and are not limited.

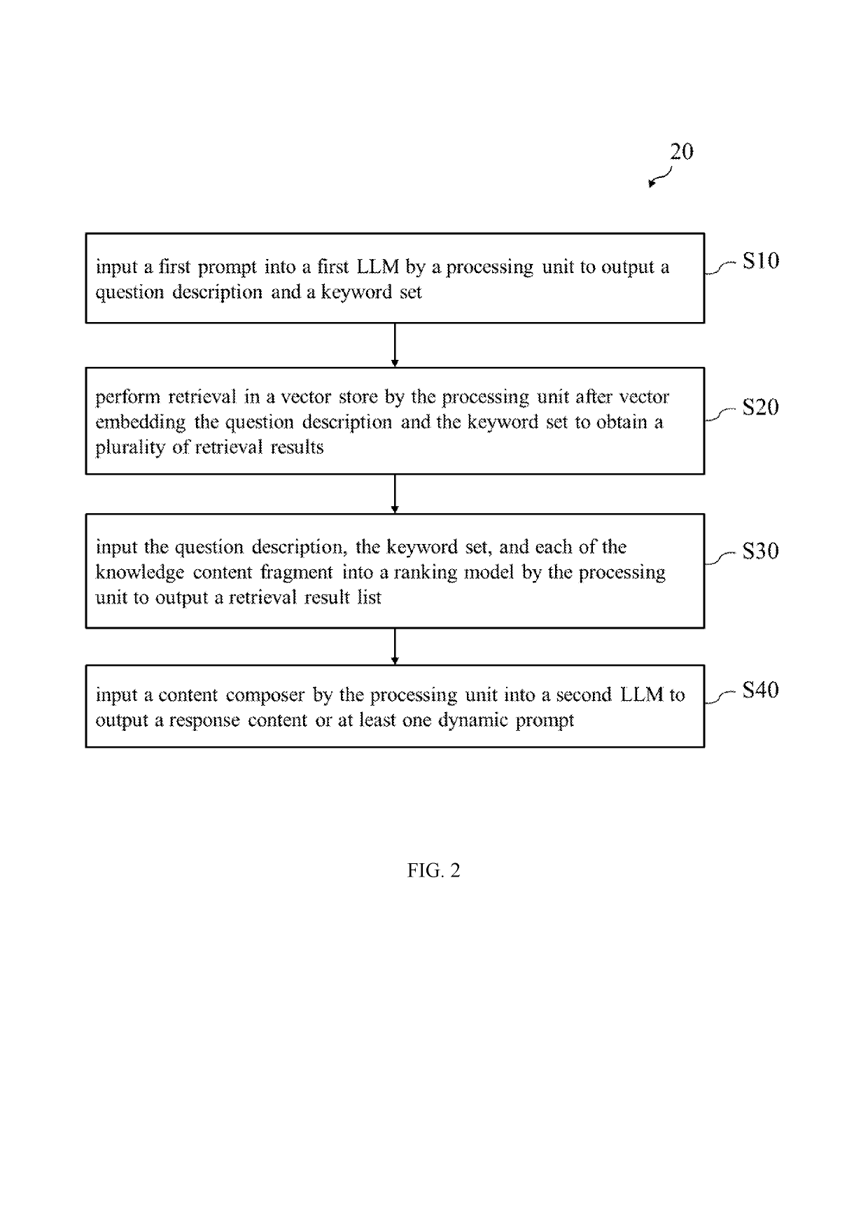

Referring to FIG. 1 and 2, when memory 11 stores one or more computer programs 14 containing a plurality of instructions, processing unit 12 executes the instructions stored in memory 11. When processing unit 12 executes these instructions, it executes the retrieval-augmented generation method for knowledge management 20 disclosed herein, which includes steps S10 to S40. The details of the steps are described below.

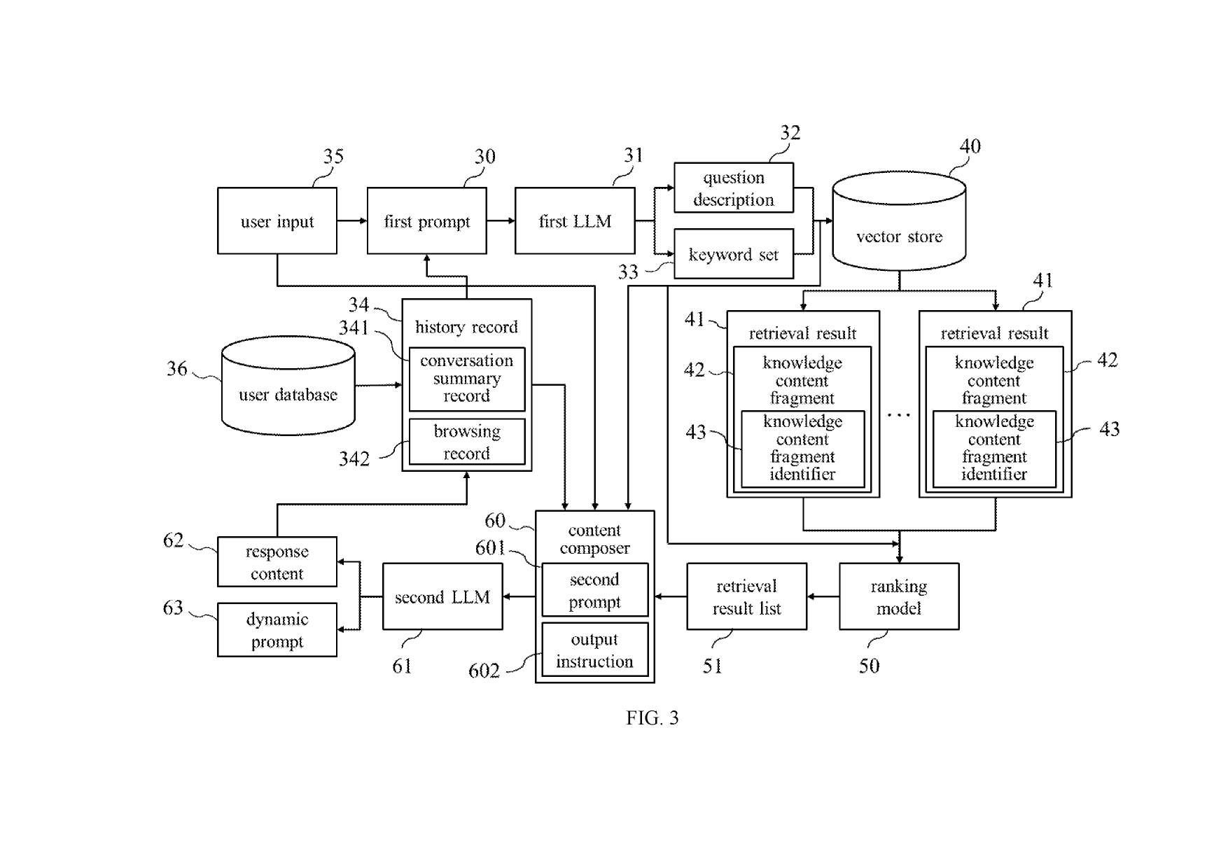

Referring to FIGS. 2 and 3, in step S10, inputting a first prompt 30 by a processing unit 12 into a first LLM 31, and then the first LLM 31 outputting a question description 32 and a keyword set 33. Wherein, the first prompt 30 instructs the first LLM 31 to refer a history record 34 to understand and augment a user input 35, thereby obtaining the question description 32 and the keyword set 33. The history record 34 is stored in a user database 36 and includes a conversation summary record 341 and a browsing record 342. Further, the first prompt 30 utilizes the conversation summary record 341 and the browsing record 342 from the history record 34 to understand the content that the user has browsed, read, and interacted with the system in the past. This content involves various forms of sources including but not limited to books, papers, multimedia, etc., to understand the intent, purpose, or causal context of the user input 35. Wherein, the conversation summary record 341 retains a record of the complete dialogue between the user and the system, or a simplified or excerpted version thereof, as short-term or long-term memory for the system, allowing it to recall past interactions with the user and maintain conversational coherence. Furthermore, the browsing record 342 records which content the user has browsed or read, specifically which paragraphs of specific sources have been browsed or read, in order to avoid recommending repetitive information in subsequent question-and-answer sessions or to explore existing content more deeply. By understanding the content of the user input 35, the first LLM 31 can enrich and augment the user input 35, further supplementing additional information for the user, to express the user's intent more completely and clearly, thereby obtaining a more precise and detailed question description 32, and extracting the keyword set 33 containing multiple keywords from this question description 32 or in combination with the user input 35, as an important basis for subsequent retrieval.

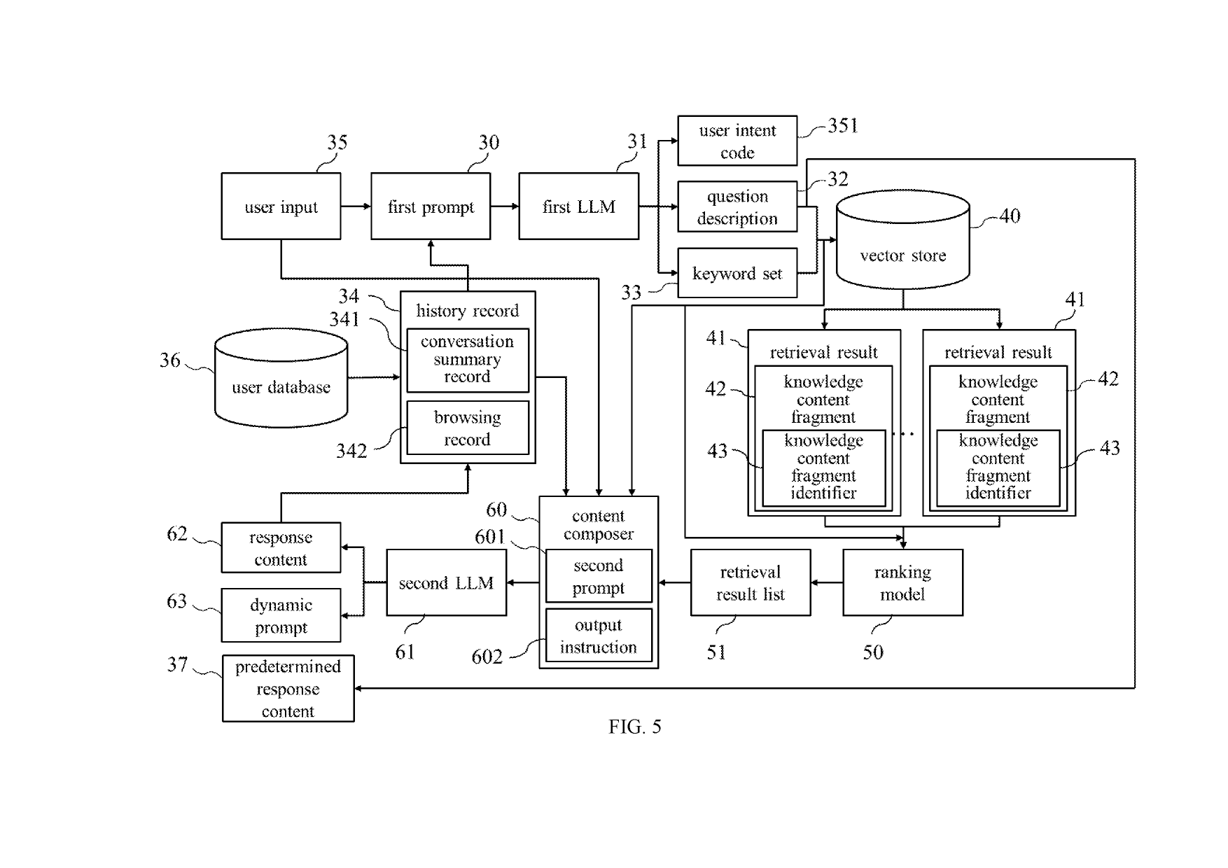

In another preferred embodiment, as shown in FIG. 5, step S10 further includes: the first prompt 30 instructs the first LLM 31 to reference an intent classification example set to recognize the intent of the user input 35 and output a user intent code 351. Wherein, the classification items of the intent classification example set are selected from one or more of the following groups: malicious attack, system performance test, product introduction, frequently asked questions, but is not limited thereto. Specifically, the intent classification example set provides at least one classification example for each classification item such as malicious attack, system performance test, product introduction, and frequently asked questions, allowing the first LLM 31 to perform in-context learning based on the intent classification example set, thereby determining which of the classification items the user input 35 are categorized into, and giving the user intent code 351. Through this recognition and classification step, data analysis can be performed on the user input 35 and used as a reference for subsequent optimization. For example, understanding the most frequently asked questions of users, and also constructing security defense mechanisms such as prompt injection or malicious garbled input attacks to identify attacks and misleading information in the user input 35 targeting the LLM, rewriting these malicious inputs into normal content that meets service requirements, preventing system crashes, and avoiding inappropriate content generation.

In another preferred embodiment, as shown in FIG. 5, step S10 further includes: the first prompt 30 instructs the first LLM 31 to reference an intent classification dataset to recognize the intent of user input 35 and output the user intent code 351. The classification categories within the intent classification dataset are selected from one or more of the following groups: malicious attack, system performance test, product introduction, and frequently asked questions. The first LLM 31 performs in-context learning based on the intent classification dataset to determine which category the user input 35 belongs to, and provides the user intent code 351. This recognition and classification step enables data analysis of the user input 35 for subsequent optimization, such as identifying frequently asked questions. It also allows construction of security defense mechanisms against prompt injection or malicious garbled input attacks by rewriting malicious inputs into content that meets service requirements, preventing system crashes, and avoiding inappropriate content generation.

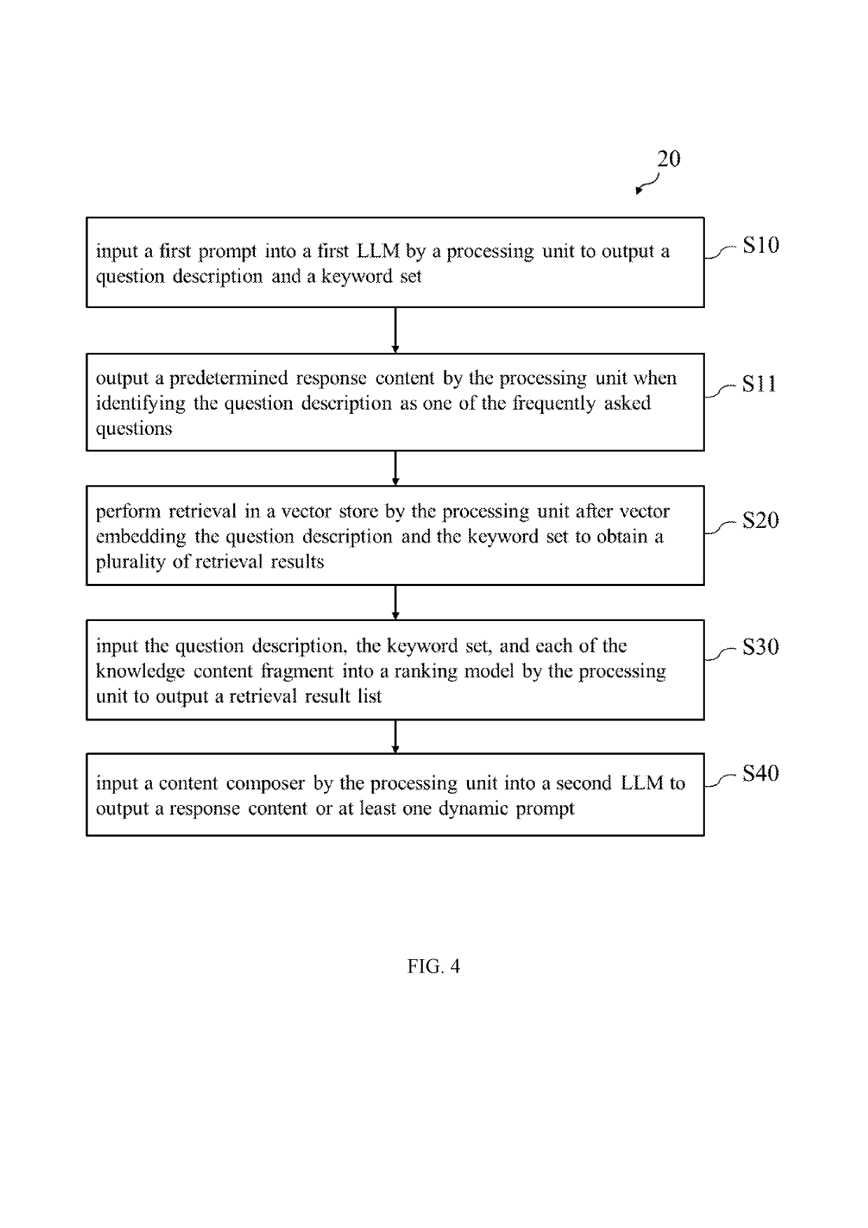

In another preferred embodiment, as shown in FIGS. 4 and 5, step S10 further includes step S11, wherein outputting a predetermined response content 37 by the processing unit 12 when identifying the question description 32 as one of the frequently asked questions. Further, after obtaining the question description 32 through step S10, processing unit 12 first recognizes the question description 32 before proceeding step S20. When the question description 32 is identified as one of the frequently asked questions, a predetermined response content 37 is outputted and subsequent steps S20, S30, and S40 are terminated, thereby bypassing intermediate retrieval, ranking, and structuring processes to directly provide a predetermined response and conserve operational resources and time.

In step S20, as shown in FIGS. 2 and 3, performing retrieval in a vector store 40 by the processing unit 12 after vector embedding the question description 32 and keyword set 33. This produces a plurality of retrieval results 41, each of the retrieval result 41 including a knowledge content fragment 42. Each of the knowledge content fragment 42 has a knowledge content fragment identifier 43, which corresponds to a specific text source for identifying the origin of the knowledge content fragment 42 within the vector store 40. The knowledge content fragment identifier 43 can be encoded using various encoding rules, such as including a text source identifier, paragraph level, and sequence order to add more information related to the knowledge content fragment 42. Further, the vector store 40 stores pre-divided texts, indexed data, and converted vectors. The vector store 40 could be one or more databases selected from groups: book database, paper database, or multimedia database. In one or more embodiments, it can also be other databases of specific data such as paper databases, contract databases, or report databases, but is not limited to these. For example, in the book database, the knowledge content fragment identifier 43 may include an ISBN code of the book.

As shown in FIGS. 2 and 3, in step S30, inputting the question description 32, the keyword set 33, and each of the knowledge content fragment 42 into a ranking model 50 by the processing unit 12 to output a retrieval result list 51. Wherein, the ranking model 50 compares the similarity between the question description 32, the keyword set 33, and each of the knowledge content fragment 42, assigning a weight value to each of the retrieval result 41. The ranking model 50 then sorts the retrieval results 41 in descending order of the weight value and filters out a specific number of retrieval results 41 based on a predetermined filter parameter to obtain the retrieval result list 51. For example, if step S20 generates 50 retrieval results 41, they are sorted from largest to smallest by the weight value, and the filter parameter is set to 10, then the top 10 of the retrieval results 41 with the highest weights are retained and output as the retrieval result list 51. It should be particularly noted that filtering the retrieval results 41 is an important verification mechanism and quality control procedure to filter out seemingly relevant but actually ineffective content, ensuring that the information provided for subsequent steps is high-quality and useful. Through step S30, filtered, weighted, and sorted of the retrieval result list 51 is outputted, wherein each of the knowledge content fragment 42 in the retrieval result list 51 can be traced back to and cross-referenced with the source and sequence of each of the knowledge content fragment 42 through the knowledge content fragment identifier 43. For example, the index includes a correspondence between text source identifiers and the knowledge content fragment identifier 43 to identify the origin and sequence.

As shown in FIGS. 2 and 3, in step S40, inputting a content composer 60 by the processing unit 12 into a second LLM 61 to output a response content 62 or at least one dynamic prompt 63. Wherein, the content composer 60 includes a second prompt 601 and an output instruction 602 (system prompt/system instruction). The second prompt 601 comprises the user input 35, the history record 34, the question description 32, the keyword set 33, and the retrieval result list 51, and is aggregated according to the instructions of the content composer 60. According to the output instruction 602 indicating the number of words generated, the level of detail, style, or way, the response content 62 or the dynamic prompt 63 is generated. The dynamic prompt 63 is an interactive prompt that instructs the second LLM 61 to further generate at least one in-depth thinking or exploration topic, providing continued dialogue for the user. For example, it suggests the user read specific content of a particular text related to the current conversation or ask more in-depth questions. Alternatively, it recommends other works by the author of the text, other specific texts on similar topics, or guides the user to explore different texts. It can also convert irrelevant questions into dynamic prompts, such as expanding from knowledge content fragments 42 that were not output into the retrieval result list 51 in step S30 and recommending potentially interesting extended themes or content to the user. Further, the content composer 60 is a task instruction manual specifically provided for the second LLM 61 to perform final reasoning and generating. The second prompt 601 dynamically integrates basic information such as the user input 35, the history record 34, the question description 32, the keyword set 33, and the retrieval result list 51; and the specific instructions in the output instruction 602 include defining the response language, topics to be generated, whether to generate an index table, and response methods for different users, but are not limited to this. By combining the second prompt 601 with the output instruction 602, all necessary information is integrated into the content composer 60, so that the second LLM 61 does not need to understand the previously undergone retrieval, background understanding, data processing, and other processes. It can independently and accurately generate the response content 62 or the dynamic prompt 63 by simply reading this complete and structuralized of the content composer 60. This achieves decontextualization of data input, avoiding the use of commercial large language models outside the local environment while also providing source data content to the commercial large language model for learning and training, thereby protecting confidential data. On the other hand, it can also delegate tasks from each process to two or more identical or different, local or non-local large language models, achieving high modularity and flexibility. For example, two different non-local large language models can be used as the first LLM 31 and the second LLM 61, while steps S10 and S40 are processed separately; or a local large language model can be used as the first LLM 31, and another is selected as a non-local large language model as the second LLM 61. Two different local large language models can also be used as the first LLM 31 and the second LLM 61. Users can consider cost and computational capabilities to configure them accordingly. It should be particularly noted that in step S40, the response content 62 or the dynamic prompt 63 may be generated individually or together, depending on the system's default response.

In one preferred embodiment, the processing unit 12 can be a single processor or include multiple processors. When the processing unit 12 comprises multiple processors, these processors may be located within the same device or separately located in different devices; when the devices are stored in different locations, the retrieval-augmented generation method for knowledge management disclosed herein can be implemented as a remote or cloud implementation; when at least one of the steps, sub-steps, or computer programs is executed by the processors in the devices located in different places, the retrieval-augmented generation method for knowledge management disclosed herein can be implemented as a multi-user collaborative method. Therefore, the collaborative process of the present invention can be performed through asynchronous execution in different locations. In other words, the retrieval-augmented generation method for knowledge management disclosed herein is not limited to simultaneous, on-site, same device, or single person operation.

In summary, the retrieval-augmented generation method and system for knowledge management provided by the present invention employ at least two large language models (LLMs) in a staged manner to process data, thereby decontextualizing the input data and avoiding to provide the original data content to a single external commercial LLM for learning and training. This effectively protects confidential data. Furthermore, users can configure the models based on cost and computational resources, which helps save the expense of building their own LLMs. Moreover, the first LLM understands and augments the user input to generate the question description and the keyword set, followed by the ranking model that filters out a high-quality of the retrieval result list. Finally, the second LLM only needs to read the integrated content composer to independently and accurately generate the response content or the dynamic prompts, effectively utilizing multiple LLMs to complete complex instructions. Ultimately, using at least two LLMs for distributed processing improves computational efficiency. When the system recognizes a question description as a common question, it can directly output a pre-defined response content and stop subsequent retrieval, ranking, and structuring processes, significantly saving overall operating resources and time.

It shall be noted that the above provides detailed description of the present invention along with the accompanied drawings to illustrate the technical content and features of the present invention only such that an embodiment of the present invention is provided as an example. For an ordinary person skilled in the art in the technical field of the present invention, after understanding the technical content and features of the present invention, may make simple modification, replacement or omission of components without deviating from the principle of the present invention, which shall be considered to be within the scope of the claims of the present invention

What is claimed is:

1. A retrieval-augmented generation method for knowledge management, comprising the following steps:
inputting a first prompt by a processing unit into a first LLM to output a question description and a keyword set, wherein the first prompt instructing the first LLM to refer to a history record to understand and augment a user input to obtain the question description and the keyword set, the history record being stored in a user database and including a conversation summary record and a browsing record;
performing retrieval in a vector store by the processing unit after vector embedding the question description and the keyword set to obtain a plurality of retrieval results, each of the retrieval result including a knowledge content fragment;
inputting the question description, the keyword set, and each of the knowledge content fragment into a ranking model by the processing unit to output a retrieval result list, wherein the ranking model comparing the similarity between the question description, the keyword set, and each of the knowledge content fragment to assign a weight value to each of the retrieval result, and filtering and sorting each of the retrieval result based on the weight value to obtain the retrieval result list; and
inputting a content composer by the processing unit into a second LLM to output a response content or at least one dynamic prompt, wherein the content composer including a second prompt and an output instruction, the second prompt including the user input, the history record, the question description, the keyword set, and the retrieval result list being integrated according to the instructions of the content composer, and generating the response content or the dynamic prompt according to the output instruction indicating the number of words generated, the level of detail, style, or way.

2. The method according to claim 1, in step (a), the first prompt further instructs the first LLM to reference an intent classification example set to recognize the intention of the user input and output a user intent code.

3. The method according to claim 2, wherein the classification items of the intent classification example set are selected from one or more of the following groups: malicious attack, system performance test, product introduction, and frequently asked questions.

4. The method according to claim 3, further comprising a step (a1), wherein outputting a predetermined response content when the processing unit recognizes the question description as a frequently asked question.

5. The method according to claim 1, in step (b), each of the knowledge content fragment includes a knowledge content fragment identification identifier, which corresponds to a specific text source for identifying the origin of the knowledge content fragment in the vector store.

6. The method according to claim 1, in step (b), the vector store is selected from one or more of the following database groups: book database, paper database, or multimedia database.

7. The method according to claim 1, in step (d), the dynamic prompt instructs the second LLM to reference the retrieval results that were not outputted into the retrieval result list and expand the unused knowledge content fragments to recommend potentially interesting extended topics or contents to the user.

8. A retrieval-augmented generation system for knowledge management, comprising:
a memory for storing one or a plurality of computer programs comprising a plurality of instructions; and
a processing unit configured to execute the instructions to perform the following operations:
inputting a first prompt by a processing unit into a first LLM to output a question description and a keyword set, wherein the first prompt instructing the first LLM to refer to a history record to understand and augment a user input to obtain the question description and the keyword set, the history record being stored in a user database and including a conversation summary record and a browsing record;
performing retrieval in a vector store by the processing unit after vector embedding the question description and the keyword set to obtain a plurality of retrieval results, each of the retrieval result including a knowledge content fragment;
inputting the question description, the keyword set, and each of the knowledge content fragment into a ranking model by the processing unit to output a retrieval result list, wherein the ranking model comparing the similarity between the question description, the keyword set, and each of the knowledge content fragment to assign a weight value to each of the retrieval result, and filtering and sorting each of the retrieval result based on the weight value to obtain the retrieval result list; and
inputting a content composer by the processing unit into a second LLM to output a response content or at least one dynamic prompt, wherein the content composer including a second prompt and an output instruction, the second prompt including the user input, the history record, the question description, the keyword set, and the retrieval result list being integrated according to the instructions of the content composer, and generating the response content or the dynamic prompt according to the output instruction indicating the number of words generated, the level of detail, style, or way.

9. The system according to claim 8, in step (a), the first prompt further instructs the first LLM to reference an intent classification example set to recognize the intention of the user input and output a user intent code.

10. The system according to claim 9, wherein the classification items of the intent classification example set are selected from one or more of the following groups: malicious attack, system performance test, product introduction, and frequently asked questions.

11. The system according to claim 10, further comprising a step (a1), wherein outputting a predetermined response content when the processing unit recognizes the question description as a frequently asked question.

12. The system according to claim 8, in step (b), each of the knowledge content fragment includes a knowledge content fragment identification identifier, which corresponds to a specific text source for identifying the origin of the knowledge content fragment in the vector store.

13. The system according to claim 8, in step (b), the vector store is selected from one or more of the following database groups: book database, paper database, or multimedia database.

14. The system according to claim 8, in step (d), the dynamic prompt instructs the second LLM to reference the retrieval results that were not outputted into the retrieval result list and expand the unused knowledge content fragments to recommend potentially interesting extended topics or contents to the user.
